(19) United States
(12) Patent Application Publication
(10) Pub. No.: US 2014/0238207 A1
(43) Pub. Date: Aug. 28, 2014

(54) ADHESIVE TAPE CUTTING METHOD AND ADHESIVE TAPE CUTTING APPARATUS

(71) Applicant: NITTO DENKO CORPORATION, Ibaraki-shi (JP)

(72) Inventors: Yasuji Kaneshima, Kameyama-shi (JP); Naoki Ishii, Kameyama-shi (JP); Masayuki Yamamoto, Kameyama-shi (JP)

(73) Assignee: NITTO DENKO CORPORATION, Ibaraki-shi (JP)

(21) Appl. No.: 14/156,298

(22) Filed: Jan. 15, 2014

(30) Foreign Application Priority Data
Feb. 28, 2013 (JP) 2013-039013

(51) Int. Cl. B26D 1/01

(52) U.S. Cl. CPC B26D 1/015
USPC 83/27; 83/102

(57) ABSTRACT

A strip adhesive tape except for a portion on a notch of a wafer W is cut by contacting a cutter of a first cutting mechanism along an outer periphery of the wafer. The adhesive tape cut out into a wafer shape is reeled and collected while being separated. Thereafter, the wafer with the adhesive tape is transported to a second cutting mechanism. The second cutting mechanism cuts out the portion of the adhesive tape on the notch with a cutter having the same shape as that of the notch.

### TECHNICAL FIELD

The present invention relates to an adhesive tape cutting method and an adhesive tape cutting apparatus that cuts an adhesive tape for surface protecting of a workpiece such as a semiconductor wafer or an electron substrate or an adhesive tape (an encapsulating sheet) for encapsulating a circuit surface of a semiconductor wafer or an electron substrate.

### BACKGROUND ART

Various method of cutting a protective sheet joined to a circuit surface of a semiconductor wafer along an outer periphery of the semiconductor wafer have been suggested and implemented. The cutting method uses a cutter provided on a tip end of a multi axis robot. The multi axis robot has a plurality of arms connected rotatably around a longitudinal shaft or a pivot shaft. That is, the protective sheet is cut with the cutter contacting along an arc and a notch of the semiconductor wafer while an angle of the cutter is changed. See Japanese Patent Publication No. 2007-194321A.

### SUMMARY OF INVENTION

### Technical Problem

However, the following problem arises with the conventional methods.

Specifically, the wafer needs to be thinner in response to rapid advance in application in recent years. The wafer needs to be thinned to have a thickness of 100 μm to 50 μm sometimes up to around 25 μm. Accordingly, the wafer itself has decreased rigidity. Consequently, a protective tape thicker than ever is likely to be joined for obtaining surface protection and increased rigidity of the wafer prior to a back grinding process.

The thicker protective tape is difficult to deform elastically. This causes difficulty in varying a travelling direction of the cutter sharply from the arc to the V-notch of the outer periphery of the wafer. Forcible variation in the travelling direction of the cutter under this condition may cause cracks or fractures in the wafer. Alternatively, this may cause nicks of the cutter.

Moreover, instead of molding semiconductor devices with an epoxy resin, an encapsulating sheet with a resin layer formed on a separating liner is pressed to encapsulate a plurality of surfaces of semiconductor devices collectively. Such a method has been suggested. The resin layer is thicker than the surface-protective protective tape, and has appropriate hardness. Consequently, similar to the above protective tape, this leads to difficulty in cutting the encapsulating sheet while the cutter contacts along the outer periphery of the wafer.

The present invention has been made regarding the state of the art noted above, and its primary object is to provide an adhesive tape cutting method and an adhesive tape cutting apparatus that allow an adhesive tape to be cut into a shape of a workpiece with high accuracy without damaging the workpiece regardless of various properties of the adhesive tape joined to the surface of the workpiece.

### Solution to Problem

The present invention is configured as under to achieve the above object.

One aspect of the present invention discloses an adhesive tape cutting method for cutting an adhesive tape joined to an entire surface of a workpiece. The method includes a first cutting step of cutting the adhesive tape except for a portion of the adhesive tape on a notch of the workpiece by contacting a first cutting edge of a first cutting mechanism along an outer periphery of the workpiece; a second cutting step of cutting the portion of adhesive tape on the notch with a second cutting edge of a second cutting mechanism having a shape equal to the notch; and a tape collecting step of collecting the adhesive tape cut out in a shape of the workpiece.

With the above method, the second cutting edge having the same shape as that of the notch cuts out the portion of the adhesive tape on the notch of the workpiece. This eliminates necessity of variation of a cutting direction of the second cutting edge along the notch, which variation is needed for a tapered cutting edge. Consequently, no excessive stress is applied to the notch during cutting of the adhesive tape, and thus the workpiece has no cracking or chipping. In other words, the adhesive tape can be cut with high accuracy into the shape of the workpiece including the notch. In addition, nicks of the second cutting edge can be suppressed.

Here, an order of performing the first cutting step and the second cutting step is not particularly limited. Consequently, the second cutting step may be performed after the first cutting step, or the first cutting step may be performed after the second cutting step.

Moreover, in the above method, the adhesive tape may be cut out in the second cutting step while the portion of the adhesive tape on the notch is sucked.

The method allows sucking and removing chips generated upon cutting. Here, the chip includes, for example, a solid particle contained in the adhesive layer of the adhesive tape and a chip of a base material of the adhesive tape. Moreover, the first cutting step is performed firstly. That is, when the adhesive tape except for the portion on the notch is cut into a substantially workpiece shape and thereafter the portion on the notch is cut, the adhesive tape having the notch shape can be sucked and removed.

Moreover, in the above method, defective cutting of the portion of the adhesive tape on the notch may be inspected after the second cutting step.

The method allows detection of a condition where the adhesive tape remains from the defective cutting of the portion of the adhesive tape on the notch. Cutting may be performed again to the portion on the notch in accordance with the resultant of the detection.

Moreover, in the second cutting step of the above method, the adhesive tape may be cut with the second cutting edge piercing the adhesive tape from an adhesive layer toward a base material while at least the portion of the adhesive tape on the notch on the base material is held.

This method is preferable when the adhesive tape is thicker than the workpiece. Specifically, when the adhesive tape is cut from the adhesive layer while the workpiece is held on the holding table, a space is generated at a notch between the holding table and the adhesive tape. Under this condition, stress is applied to the notch, the stress occurring from cutting while pressing the thick adhesive tape by piercing the adhesive tape with the second cutting edge. Consequently, the workpiece may have cracking or chipping at the notch thereof.

On the other hand, when the second cutting edge pierces the adhesive tape from the adhesive layer toward the base material while the adhesive tape on a base material side is held, the second cutting edge passes through the notch to press only the adhesive tape. Consequently, damages on the notch can be suppressed during cutting the adhesive tape.

Moreover, the adhesive tape may be cut while at least the second cutting edge of the first cutting edge and second cutting edge is heated with a heater.

The method causes the heater to heat the adhesive tape for softening. Accordingly, the adhesive tape becomes easy to be cut.

The present invention is also configured as under to achieve the above object.

Another aspect of the present invention discloses an adhesive tape cutting apparatus for cutting an adhesive tape joined to an entire surface of a workpiece. The apparatus includes a first cutting mechanism configured to cut the adhesive tape except for a portion of the adhesive tape on a notch of the workpiece by contacting a first cutting edge along an outer periphery of the workpiece; a second cutting mechanism configured to cut out the portion of the adhesive tape on the notch with a second cutting edge having a shape equal to the notch; and a tape collecting mechanism configured to collect the adhesive tape cut out into a shape of the workpiece.

The above construction allows the second cutting edge having the same shape as that of the notch to cut out the adhesive tape on the notch. Accordingly, the method can be performed suitably.

Moreover, the apparatus preferably includes a suction mechanism configured to suck the notch. It is preferable that the suction mechanism is accommodated in a recess of the second cutting edge caving into a notch shape and has a nozzle having a suction port directed toward a tip of the second cutting edge.

Such the construction allows suction and removal of the chips generated upon cutting the portion of the adhesive tape on the notch. Consequently, contamination of the workpiece by the chips can be suppressed.

Moreover, the apparatus may include a heater configured to heat the second cutting edge.

Such the construction allows cutting of the adhesive tape while the adhesive tape is softened with the heater. This ensures to achieve cutting and removal of the minute portion of the adhesive tape on the notch.

The apparatus may include a detector configured to detect whether or not the portion of the adhesive tape on the notch is cut and configured to output a detection signal; and a determination section configured to determine defective cutting of the portion of the adhesive tape on the notch in accordance with the detection signal from the detector.

Such the construction allows detection of defective cutting of the portion of the adhesive tape on the notch. That is, cut is performed again when the defective cutting is detected, ensuring to cut and remove the portion of the adhesive tape on the notch.

### Advantageous Effects of Invention

The adhesive tape cutting method and the adhesive tape cutting apparatus of the present invention allow cutting of the adhesive tape into a shape of the workpiece containing the notch with high accuracy without damages such as cracking or chipping regardless of types and properties of the adhesive tape containing a sheet for workpiece surface protection or for workpiece surface encapsulation.

It is to be understood that both the foregoing general description and the following detailed description are exemplary and explanatory and are intended to provide further explanation of the invention as claimed.

### BRIEF DESCRIPTION OF DRAWINGS

For the purpose of illustrating the invention, there are shown in the drawings several forms which are presently preferred, it being understood, however, that the invention is not limited to the precise arrangement and instrumentalities shown.

FIG. 1 is an overall perspective view of an adhesive tape joining apparatus.

FIG. 2 is a plan view of the adhesive tape joining apparatus.

FIG. 3 is a perspective view of a principal part of the adhesive tape joining apparatus.

FIG. 4 is a front view illustrating the surrounding of a first cutting mechanism of the adhesive tape joining apparatus.

FIG. 5 is a front view illustrating the surrounding of a second cutting mechanism of the adhesive tape joining apparatus.

FIG. 6 is a plan view illustrating the surrounding of the second cutting mechanism.

FIG. 7 is a schematic front view illustrating operation of joining an adhesive tape.

FIG. 8 is a schematic front view of cutting the adhesive tape with the first cutting mechanism

FIG. 9 is a schematic front view of separating the adhesive tape.

FIG. 10 is a schematic front view of collecting a cut-out adhesive tape.

FIG. 11 is a perspective view of cutting the adhesive tape with the second cutting mechanism.

FIG. 12 is an enlarged partial view of cutting the adhesive tape with the second cutting mechanism.

FIG. 13 is a front view of cutting the adhesive tape with the second cutting mechanism.

FIG. 14 is a longitudinal sectional view of a principal part of a cutter unit according to one modification.

### DESCRIPTION OF EMBODIMENTS

Description will be given hereinafter of embodiments of the present invention with reference to drawings. Here the embodiments are to be described by taking as one example an apparatus configured to join a surface-protective adhesive tape to a semiconductor wafer (hereinafter, simply referred to as a “wafer”).

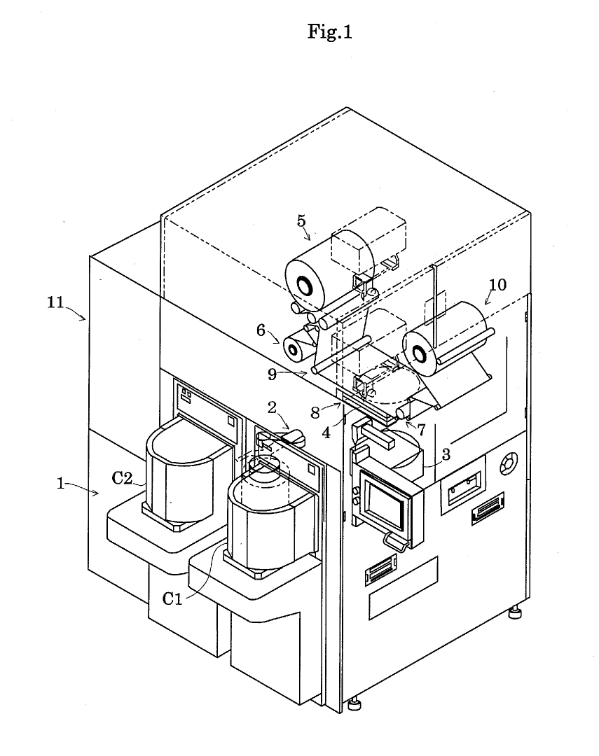

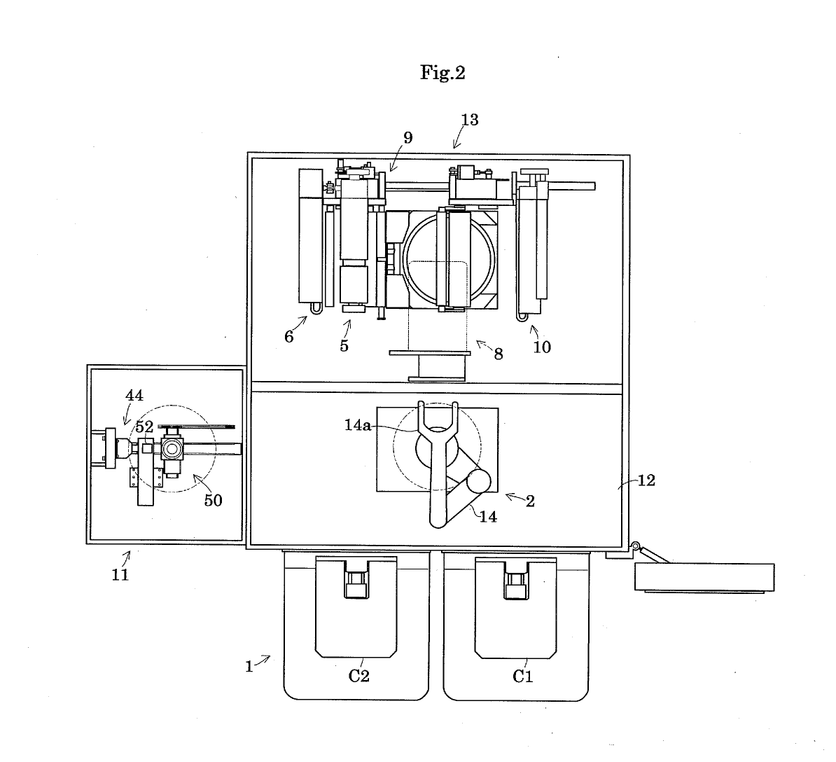

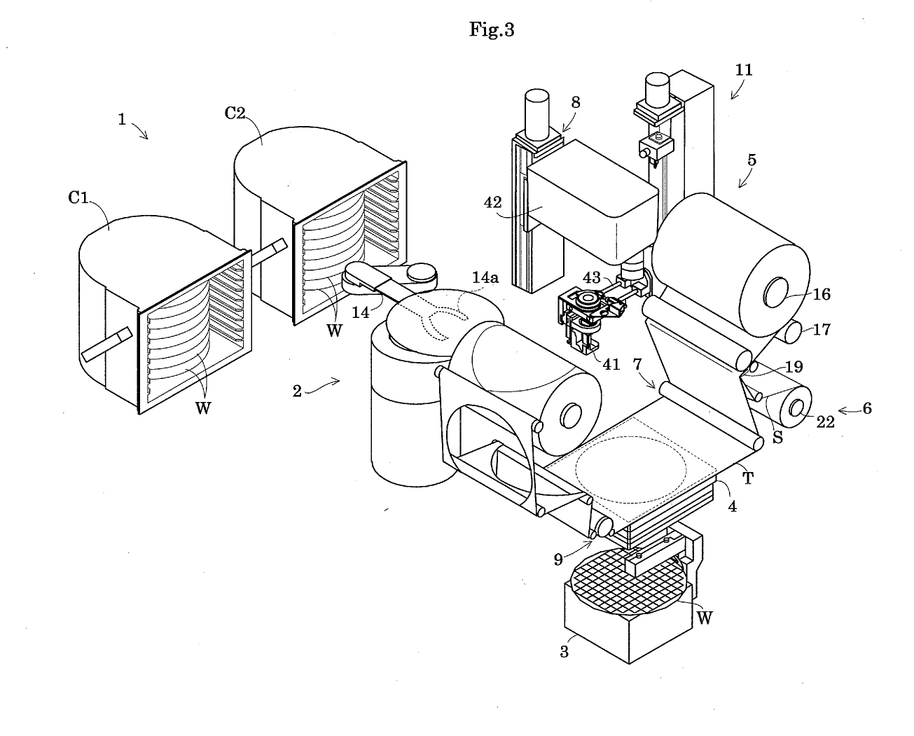

FIG. 1 is an overall perspective view of an adhesive tape joining apparatus. FIG. 2 is a plan view of the adhesive tape joining apparatus. FIG. 3 is a perspective view illustrating a principal part of the adhesive tape joining apparatus.

As illustrated in FIGS. 1 and 2, an adhesive tape joining apparatus includes a wafer supply/collecting section 1, a wafer transport mechanism 2, an alignment stage 3, a holding table 4, a tape supplying section 5, a separator collector 6, an joining unit 7, a first cutting mechanism 8, a separation unit 9, a tape collector 10, and a second cutting mechanism 11. Here, the wafer supply/collecting section 1, the wafer transport mechanism 2, the alignment stage 3, and the holding table 4 are arranged on a top face of a base 12. The tape supplying section 5 and the tape collector 10 are arranged on a front face of an upright wall erected on the top face of the base 12. The joining unit 7 and the separation unit 9 are arranged adjacent to a lower opening of the upright wall. A unit driving section 13 is arranged on a back of the upright wall. The second cutting mechanism 11 adjoins to a side face of the base 12. Each element is to be described hereinunder in detail.

The wafer supply/collecting section 1 loads cassettes C1 and C2 on a cassette table. A wafer W prior to joining of an adhesive tape T is inserted and accommodated into the cassette C1, whereas a, wafer W after joining of the adhesive tape T is inserted and accommodated into the cassette C2. Here, the wafers W are accommodated into each of the cassettes C1 and C2 under a condition where each of circuit surfaces thereof is directed upward with a given vertical space in a stack manner.

The wafer transport mechanism 2 includes a robot arm 14. The robot arm 14 can reciprocate horizontally, can rotate, and can move upward and forward. The robot aim 14 has a U-shaped suction holder 14a at a tip end thereof. The suction holder 14a picks up a wafer W from either the cassette C1 or C2 of the wafer supply/collecting section 1. Then the suction holder 14a transports the wafer W to the alignment stage 3, the holding table 4, the second cutting mechanism 11, and the wafer supply/collecting section 1, in this order.

The alignment stage 3 turns the wafer W while suction-holding a rear face of the wafer W with a suction pad to perform detection of a notch formed on an outer periphery of the wafer W. Here, the suction pad moves vertically from a holding face of the alignment stage 3. Then the alignment stage 3 aligns the center of the wafer W in accordance with the resultant of the detection.

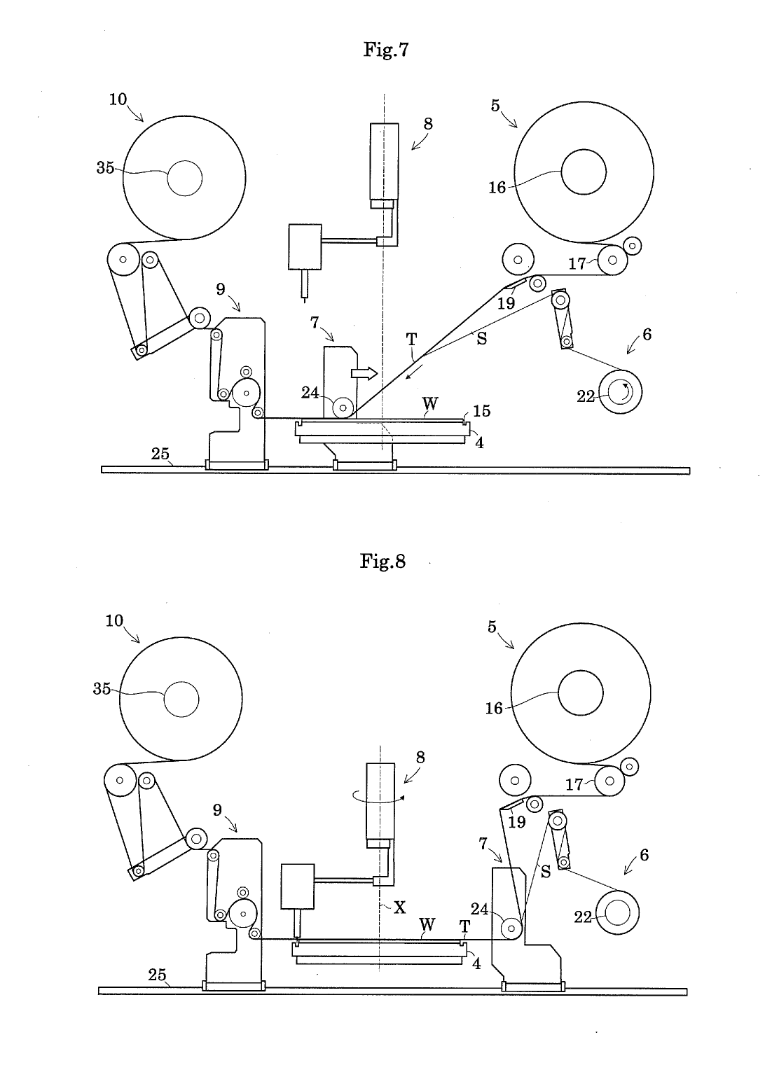

The wafer transport mechanism 2 moves the wafer W to the holding table 4 and places the wafer W in a given position. As illustrated in FIGS. 4 and 7, the holding table 4 performs vacuum suction to the wafer W. Moreover, the holding table 4 has a cutter travelling groove 15 on a top face thereof. The cutter travelling groove 15 is provided for turning a cutter 41 of a first cutting mechanism 8, to be mentioned later, along an outer contour of the wafer W to cut the adhesive tape T. The holding table 4 further includes a suction holder 15a at the center thereof. The suction holder 15a moves outward upon transporting the wafer.

As illustrated in FIGS. 3 and 4, the tape supplying section 5 reels the adhesive tape T with a separator S fed out from a supply bobbin 16 using a feed roller 17 and a guide roller 18, and then guides the adhesive tape T to a separation guide bar 19 formed into a knife edge. Then, the adhesive tape T is folded back at a leading edge of the separation guide bar 19, whereby the separator S is separated from the adhesive tape T. The adhesive tape T with the separator S separated therefrom is guided to the joining unit 7. The separator S separated from the adhesive tape T is guided to the separator collector 6.

The feed roller 17 guides the adhesive tape T between a pinch roller 19 and the feed roller 17. The feed roller 17 is rotated by a motor 21. If necessary, the feed roller 17 forcibly feeds the adhesive tape T.

The supply bobbin 16 is interlocked with and coupled to an electromagnetic brake so as to receive appropriate rotational resistance. As a result, the adhesive tape T is prevented from being excessively unreeled from the supply bobbin 16.

The separator collector 6 includes a collection bobbin 22 reeling the separator S separated from the adhesive tape T. A motor 23 controls forward/backward rotation of the collection bobbin 22.

The joining unit 7 includes a joining roller 24 that is shiftable vertically with a cylinder. Moreover, the joining unit 7 is entirely supported so as to be movable horizontally along a guide rail 25. The joining unit 7 is allowed to reciprocate in a screw-feed manner through a screw shaft 27 rotated with a motor 26 in the forward/backward direction.

The separation unit 9 includes a separation roller 28, a feed-out roller 29, a guide roller 30, and a pinch roller 31. The feed-out roller 29 is driven with a motor.

The separation unit 9 is entirely supported on a guide rail 25 so as to be movable horizontally along the guide rail 25, and is allowed to reciprocate in a screw-feed manner through a screw shaft 33 rotated with a motor 32 in a forward/backward direction.

The pinch roller 31 moves upward and downward with a cylinder. The pinch roller 31 cooperates with the feed-out roller 29 to pinch the adhesive tape T.

The tape collector 10 includes a collection bobbin 35. The collection bobbin 35 is driven with a motor and is rotated in a direction of reeling an adhesive tape cut into a circular shape.

The first cutting mechanism 8 is provided with a support arm 43 below a movable table 42. The support arm 43 is movable upward and downward, and is turnable about a vertical axis X on the center of the holding table 4. The support arm 43 has a free end provided with a cutter unit 44. The cutter unit 44 includes a cutter 41 having a tapered blade edge directed downward. When the support arm 43 turns about the vertical axis X, the cutter 41 travels along an outer periphery of the wafer W. Consequently, the adhesive tape T is cut into a circular shape.

The second cutting mechanism 11 includes a holding table 50, a cutter unit 51, and a camera unit 52.

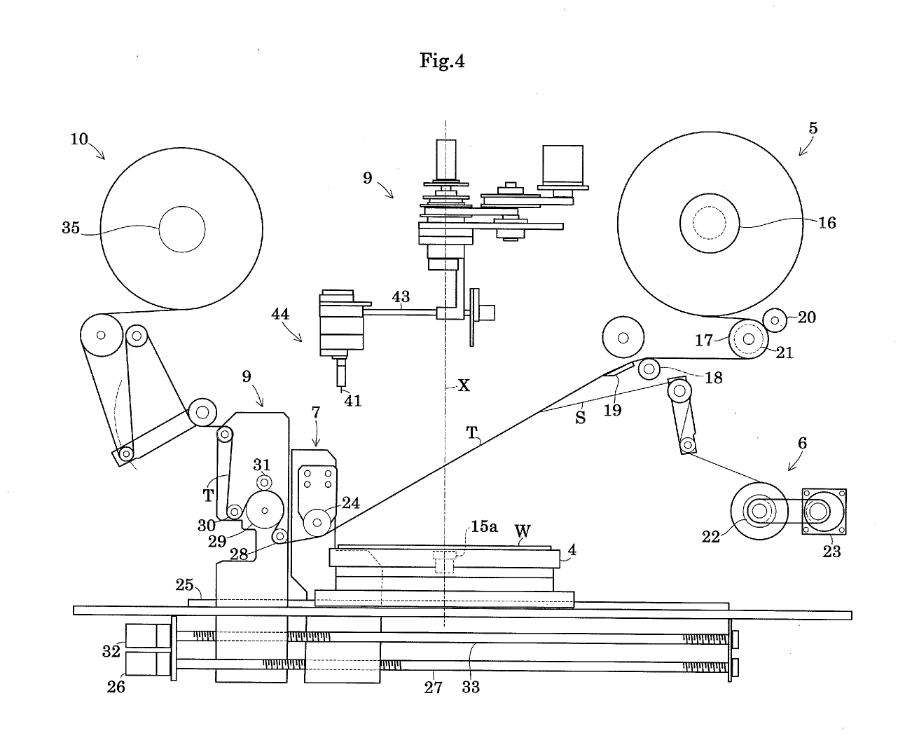

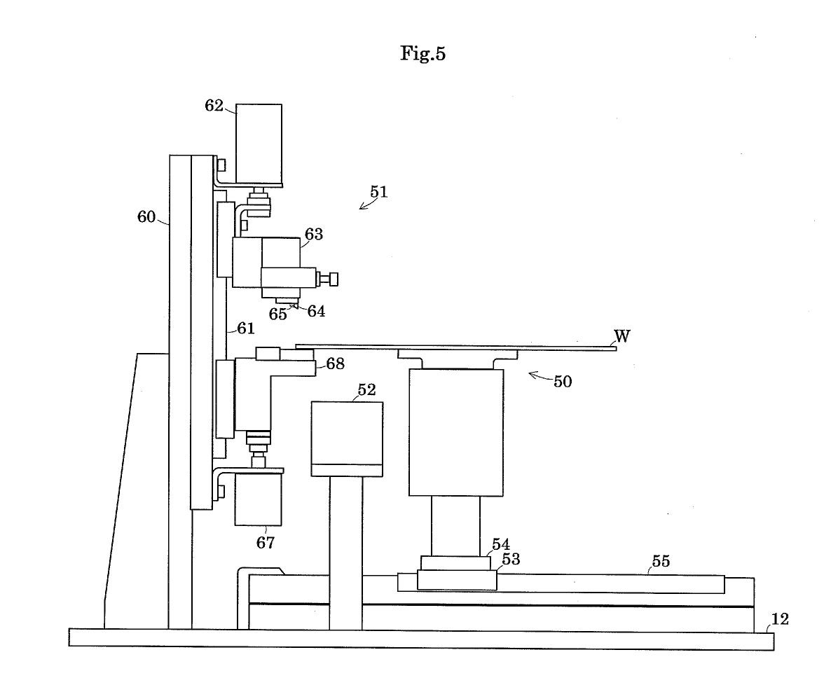

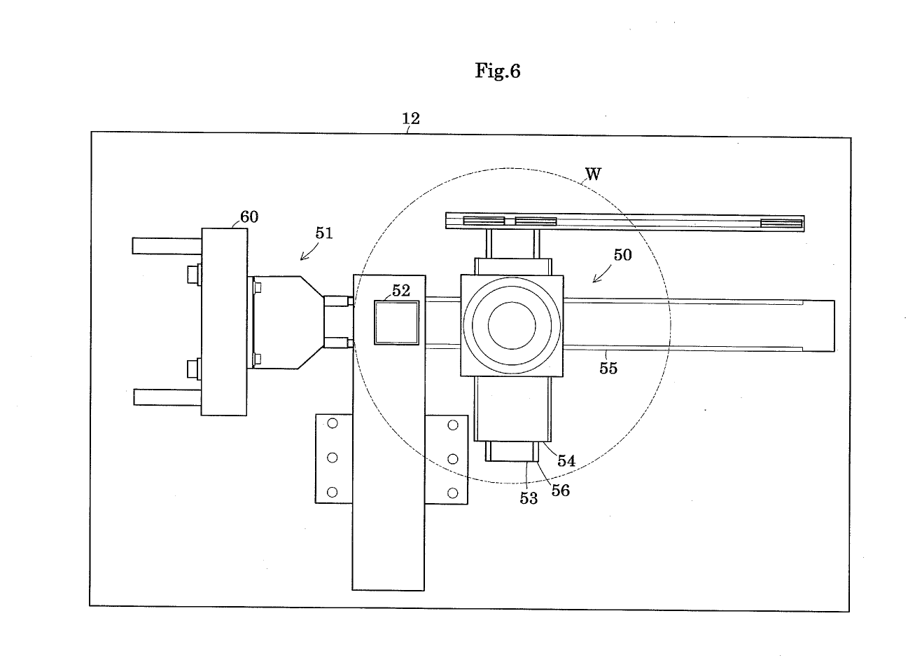

As illustrated in FIGS. 5 and 6, the holding table 50 has a suction surface having a smaller diameter than that of the wafer W. The suction surface vacuum-sucks the rear face of the wafer W transported from the wafer transport mechanism 2 and placed thereon in a given alignment position. Moreover, the holding table 50 is movable forward/backward and horizontally with the first movable board 53 and the second movable board 54. Furthermore, the holding table 50 is turnable about the central axis X with a pivoting motor.

Specifically, the first movable board 53 moves horizontally along a guide rail 55 on the base 12 between the wafer transport mechanism 2 and the cutter unit 51. The second movable board 54 moves horizontally along a guide rail 56 on the first movable board 53 orthogonal to the guide rail 55.

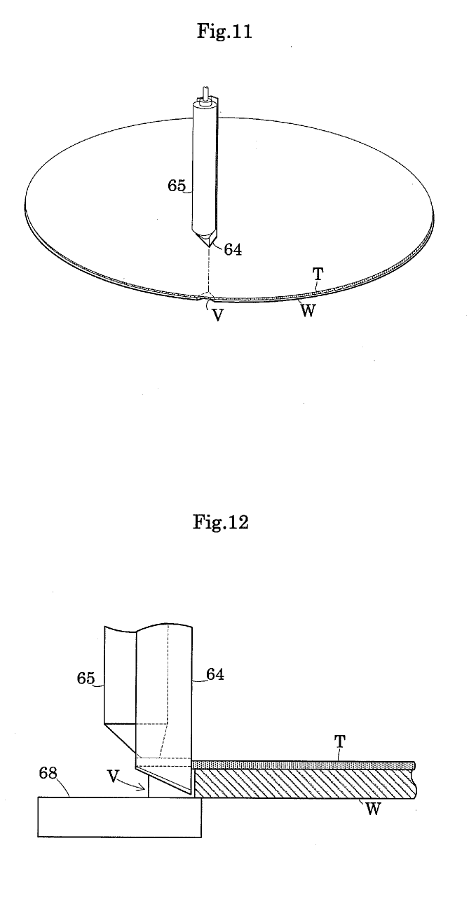

The cutter unit 51 includes a movable board 63. The movable board 63 is connected to a cylinder 62 so as to move upward and downward along a guide rail 61 orthogonal to an upright wall 60. The movable board 63 includes a cutter 64 detachably attached on the lower portion thereof via a cutter holder. As illustrated in FIG. 11, the cutter 64 has a shape equal to and slightly smaller than the notch V of the wafer W.

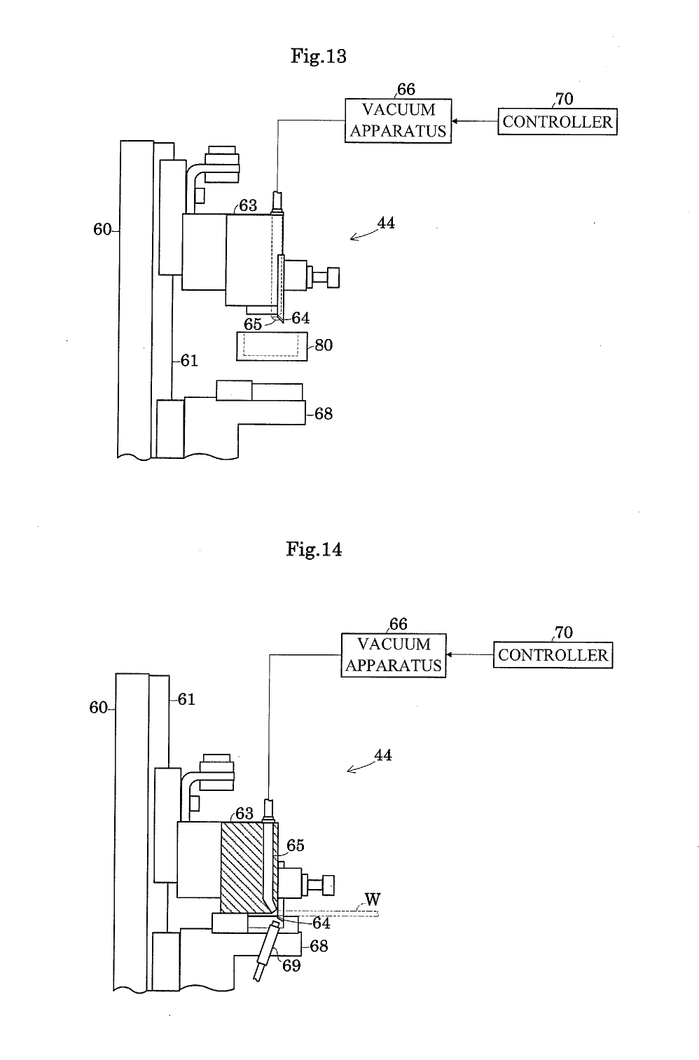

A suction nozzle 65 is arranged into a recess of the V-shaped cutter 64 with a suction port of the suction nozzle 65 being directed downward. As illustrated in FIG. 13, the suction nozzle 66 is in communication with an external vacuum apparatus 66.

As illustrated in FIG. 5, a cutter holder 68 is provided below the cutter unit 51. The cutter holder 68 is connected to a cylinder 67 so as to move upward and downward along the guide rail 61.

The camera unit 52 is provided adjacent to the holding table 50 relative to a cutting position of the cutter unit 51. The camera unit 52 takes an image of the outer periphery on the rear face of the wafer W. Data on the taken image is sent to a controller 70. The controller 70 is to be described in detail later in the following description about operations of the apparatus.

Next, with reference to FIGS. 4 to 12, description will be given of a series of operations for joining the surface-protective adhesive tape T to the surface of the wafer W using the apparatus in the foregoing embodiment.

When a joining command is issued, the robot arm 14 in the wafer transport mechanism 2 moves to the cassette C1 placed on a cassette table 12. The wafer holder 14a of the robot arm 14 is inserted between the wafers housed in the cassette C1. Then, the wafer holder 14a suction-holds the rear face of the wafer W, transports the wafer W out of the cassette C1, and place the wafer W on the alignment stage 3.

The alignment stage 3 aligns the wafer W placed thereon using a notch formed at the outer periphery of the wafer W. The robot arm 14 again transports the aligned wafer W to place it on the holding table 4.

The holding table 4 suction-holds the wafer W placed thereon such that the center of the wafer W is aligned with the center of the holding table 4. Herein, as illustrated on the left of FIG. 4, the joining unit 7 and the separating unit 9 are each in its initial position. Moreover, the cutter 41 of the first cutting mechanism 41 is on standby in its initial position as illustrated in the upper side of FIG. 4.

Firstly, the separation unit 9 operates a cylinder to move a pinch roller 31 downward to pinch the adhesive tape DT with a feed-out roller 29.

Secondly, as illustrated in FIG. 7, the joining roller 24 moves downward and the joining unit 7 moves forward. With the movement, the joining roller 24 rolls forward (to the right in the drawing) while pressing the adhesive tape T. Herein, the adhesive tape T having a width larger than the diameter of the wafer W is gradually joined to a surface of the wafer W from the left in the drawing.

As illustrated in FIG. 8, when the joining unit 7 reaches a termination position beyond the holding table 4, the cutter 41 on standby position on the upper side moves downward into the cutter traveling groove 15 on the holding table 4, thereby piercing the adhesive tape T.

Next, when the cutter 41 moves downward and stops at a given cutting position, the support arm 43 is rotated in a given direction. Such rotation causes the cutter 41 to turn about the vertical axis X to cut the adhesive tape T along the outer periphery of the wafer W.

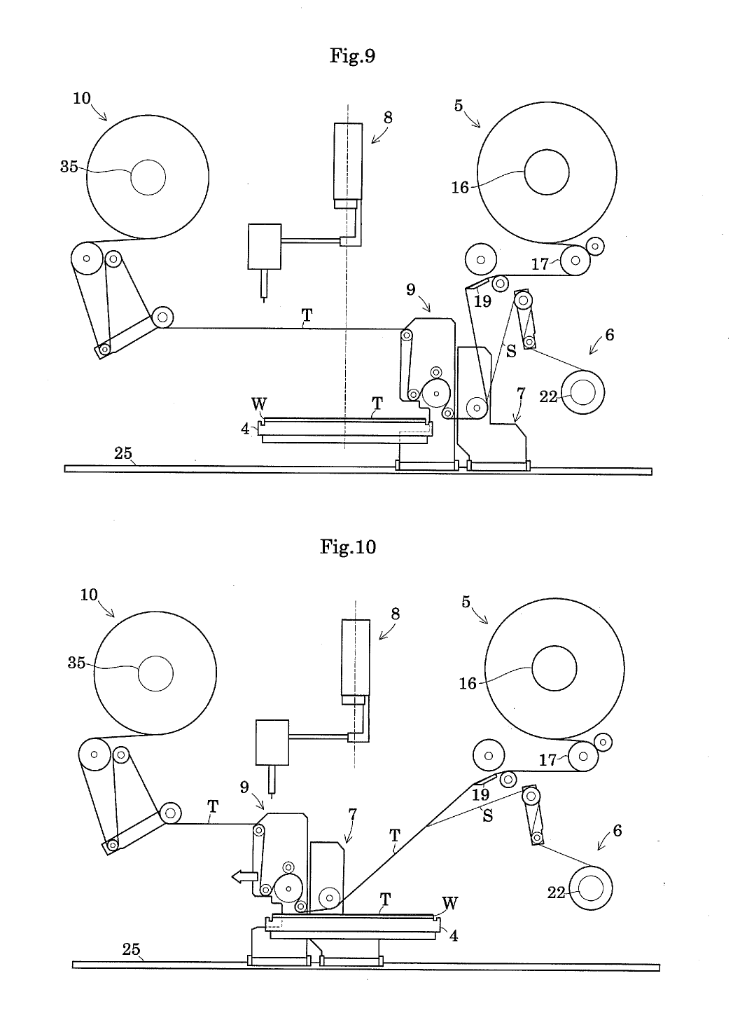

Upon completion of cutting the adhesive tape T along the outer periphery of the wafer W, the cutter 41 moves upward to its original standby position, as illustrated in FIG. 9. Simultaneously, the pinch roller 31 of the separation unit 9 moves upward to release pinching of the adhesive tape T. Then the separation unit 9 entirely moves to a separation termination position.

At this time, the feed-out roller 29 drives at a speed synchronized with a moving speed of the separation unit 9 to feed out the adhesive tape T cut into a circular shape to the tape collector 10.

Upon completion of joining the adhesive tape, the separation unit 9 and the joining unit 7 each return to its original standby position, as illustrated in FIG. 10. At this time, the adhesive tape T is unreeled from the tape supplying section 5 by a length in response to the moving speeds of the separation unit 9 and the joining unit 7.

When the separation unit 9 and the joining unit 7 reach to their standby positions, the holding table 4 releases suction-holding of the wafer W. Thereafter, the suction holder 14a of the robot arm 14 holds the wafer W to move it above the holding table 4. Moreover, the robot arm 14 transports the wafer W to the second cutting mechanism 11.

The robot arm 14 places the wafer W on the holding table 50 on standby. When the holding table 50 suction-holds the wafer W, the suction holder 14a releases suction of the wafer W. The holding table 50 moves to a position determined in advance where the outer periphery of the wafer W lies within the field of view of the camera unit 52.

When the holding table 50 reaches a given position, the camera unit 52 takes an image of the outer periphery of the wafer W with the holding table 50 rotating. The obtained image data is sent to the controller 70. The controller 70 determines the center of the wafer W and a position of the notch using pattern matching between a reference image obtained in advance and an actual image currently obtained. The controller 70 aligns the wafer W in accordance with the resultant of the determination by rotating the holding table 50 forward/backward, horizontally, or about the center of the holding table 50 such that the notch V is located in a position where the cutter 64 moves downward.

When the holding table 50 is fixed, the cutter holder 68 moves upward to hold the rear face of the wafer W containing the notch V to be processed. Thereafter, as illustrated in FIGS. 11 and 12, the cutter unit 51 moves downward to a given level to cut out the portion of the adhesive tape T covering the notch V. At this time, the suction nozzle 65 operates to suck chips generated upon cutting the portion of the adhesive tape on the notch V and the portion of the adhesive tape T cut out into a notch shape.

Moreover, a detector may detect whether or not the suction nozzle 65 sucks the piece (chip) of the adhesive tape cut into the shape of the notch V upon suction of the adhesive tape T. Examples of the detector include a non-contact optical sensor provided on the suction nozzle 65. Alternatively, upon suction of the piece of the adhesive tape, a pressure gauge may detect pressure variations or a flow meter may detect flow rate variations.

Upon completion of cutting the adhesive tape T, the cutter unit 51 and the cutter holder 68 each return to its standby position. Simultaneously, the holding table 50 moves to a position where the wafer W is transported to the robot arm 14. Moreover, as illustrated in FIG. 13, a collection box 80 moves below the suction nozzle 65 to collect the cut-out piece of the adhesive tape into the collection box by releasing suction with the suction nozzle 65.

When the robot arm 14 suction-holds the wafer W, the holding table 50 releases suction-holding of the wafer W. Thereafter, the robot arm 14 transports the wafer W to the cassette C2.

Thus, one adhesive-tape joining process is completed as described above. Thereafter, the foregoing tape joining process is performed to a given number of wafers W until completion of the tape joining process.

Thus, a series of operations of the apparatus according to the embodiment is completed.

As noted above, the first cutting mechanism 8 cuts out the adhesive tape T into a circular shape substantially equal to the shape of the wafer W. Thereafter, the second cutting mechanism 11 cuts the portion of the adhesive tape T on the notch V with the second cutting edge 64 having the same shape as the V-shaped notch V and slightly smaller than the notch V. No stress due to unnecessary pressure is applied to the wafer W during cutting the portion of the adhesive tape T on the notch V with the second cutting edge 64. Consequently, the wafer W has no cracking or chipping. In addition, the cutter 64 does not need to rotate about the longitudinal axis during the cutting step. This causes no application of unnecessary pressure also to the cutter 64. Accordingly, this suppresses nicks of the cutter 64.

Moreover, the suction nozzle 65 is provided in the recess of the cutter 64 having the shape of the notch. This allows immediate suction and removal of chips, solid particles, dust, or the piece of the adhesive tape generated upon cutting the adhesive tape T. Accordingly, contamination of the wafer W can be suppressed.

The present invention may be embodied as followings.

(1) In the second cutting mechanism 11 of the apparatus according to the above embodiment, the cutter 64 pierces the adhesive tape T from the base material to the adhesive layer with the surface of the wafer W directed upward. Alternatively, the wafer W may be reversed. Specifically, the holding table 50 suction-holds the adhesive tape T on the wafer W. Under this condition, the cutter 64 passes through the notch V to cause the cutter 64 to pierce the adhesive tape T from the adhesive layer to the base material, thereby cutting out the adhesive tape T. In this case, the camera unit 52 may be arranged above the wafer W, and the robot arm 14 may be reversed.

Such a construction is advantageous when the adhesive tape T is thicker than the wafer W or when the adhesive tape T is used having a thickness and a given hardness like an encapsulating sheet with a resin layer for encapsulating a surface of a semiconductor device.

(2) In the apparatus of the above embodiment, there is no need to integrate the suction nozzle 65 with the cutter 64. Alternatively, the suction nozzle 65 may be provided separately so as to approach a cutting portion of the cutter 64. For instance, as illustrated in FIG. 14, a channel is formed in a block for attaching a cutter receiver of the cutter unit 44. The block is used as the suction nozzle 65. In this case, it is preferable that air having a flow velocity and a flow rate suitable for promoting suction is sprayed from a nozzle 69 below the notch V with a suction hole of the nozzle 69 directed obliquely to the notch V.

(3) In the apparatus of the above embodiment, the heater may heat at least the cutter 64 of the cutter 41 of the first cutting mechanism 8 and the cutter 64 of the second cutting mechanism 11. Specifically, the heater may be embedded in the cutter unit 51 for heating the cutter 64. Such a construction allows the adhesive tape T to be cut while being softened by heat of the cutter 64.

(4) In the apparatus of the above embodiment, the portion of the adhesive tape T on the notch V may be cut and thereafter defective cutting may be detected. For instance, defective cutting is detected after the second cutting step with the cutter 64 in both the primary embodiment where the cutter 64 is integrated with the suction nozzle 65 and the modification where the suction nozzle 65 is provided adjacent to the cutting portion of the cutter 64.

Specifically, after the second cutting step, the holding table 50 moves and the camera unit 52 takes an image of the notch V. Thereafter, the obtained image is analyzed to detect whether or not the piece of the cut adhesive tape remains.

Alternatively, in the primary embodiment, the adhesive tape T is cut and simultaneously the piece of the adhesive tape is suction-held with the suction nozzle 65. Accordingly, a flow meter monitors pressure variations of the suction nozzle 65 at the same time. That is, the controller 70 identifies defective cutting when no pressure falls below a give value determined in advance in accordance with detection signals from the flow meter. Such may be adopted. Here, the controller 70 functions as the determination section of the present invention.

As noted above, when defective cutting is detected, the second cutting step is performed again in any embodiments. This ensures to eliminate the defective cutting.

(5) In the above embodiments, the portion of the adhesive tape T on the arc of the wafer W is cut firstly, and then the portion of the adhesive tape T on the notch V is cut with the second cutting mechanism 11 provided separately. This is not limitative. For instance, the portion of the adhesive tape T on the notch V may be cut, and thereafter the portion of the adhesive tape T on the arc may be cut.

In this case, the holding table 4 may function as the suction nozzle 65 in the second cutting mechanism 11. For instance, the holding table 4 is a chuck table. Accordingly, a groove for sucking the wafer W is separated from a portion for sucking and collecting the piece of the adhesive tape. Only the piece of the adhesive tape is collected with a different suction line. Such may be adopted. Alternatively, the alignment stage 3 may detect a position of the notch, and the robot arm 14 places the wafer W in accordance with information on the position such that the notch V reaches its cutting position. Moreover, the holding table 4 may move forward/backward and horizontally in a tape supply direction and may rotate about the central axis thereof for achieving enhanced positional accuracy.

(6) In the above embodiments, the substantially circular wafer W has been described as one example of the workpiece. Alternatively, the workpiece is applicable having a notch formed in a substrate in a rectangular shape, such as an oblong or a square. Moreover, the shape of the notch formed in the workpiece is not limited to a V-shape. The shape includes a bent and concave shape.

What is claimed is:

1. An adhesive tape cutting method for cutting an adhesive tape joined to an entire surface of a workpiece, comprising:
a first cutting step of cutting the adhesive tape except for a portion of the adhesive tape on a notch of the workpiece by contacting a first cutting edge of a first cutting mechanism along an outer periphery of the workpiece;
a second cutting step of cutting the portion of adhesive tape on the notch with a second cutting edge of a second cutting mechanism having a shape equal to the notch; and
a tape collecting step of collecting the adhesive tape cut out in a shape of the workpiece.

2. The adhesive tape cutting method according to claim 1, wherein
the second cutting step includes cutting out the adhesive tape while the portion of the adhesive tape on the notch is sucked.

3. The adhesive tape cutting method according to claim 1, wherein
defective cutting of the portion of the adhesive tape on the notch is inspected after the second cutting step.

4. The adhesive tape cutting method according to claim 1, wherein
the second cutting step includes cutting the adhesive tape while the second cutting edge pierces the adhesive tape from an adhesive layer toward a base material while at least the portion of the adhesive tape on the notch on the base material is held.

5. The adhesive tape cutting method according to claim 1, wherein
the second cutting step includes cutting the adhesive tape while heating at least the second cutting edge of the first cutting edge and second cutting edge with a heater.

6. An adhesive tape cutting apparatus for cutting an adhesive tape joined to an entire surface of a workpiece, comprising:
a first cutting mechanism configured to cut the adhesive tape except for a portion of the adhesive tape on a notch of the workpiece by contacting a first cutting edge along an outer periphery of the workpiece;
a second cutting mechanism configured to cut out the portion of the adhesive tape on the notch with a second cutting edge having a shape equal to the notch; and
a tape collecting mechanism configured to collect the adhesive tape cut out into a shape of the workpiece.

7. The adhesive tape cutting apparatus according to claim 6, further comprising:
a suction mechanism configured to suck the notch.

8. The adhesive tape cutting apparatus according to claim 7, wherein
the suction mechanism is accommodated in a recess of the second cutting edge caving into a notch shape, and has a nozzle having a suction port directed toward a tip of the second cutting edge.

9. The adhesive tape cutting apparatus according to claim 6, further comprising:
a heater configured to heat the second cutting edge.

10. The adhesive tape cutting apparatus according to claim 6, further comprising:
a detector configured to detect whether or not the portion of the adhesive tape on the notch is cut and configured to output a detection signal; and
a determination section configured to determine defective cutting of the portion of the adhesive tape on the notch in accordance with the detection signal from the detector.
